(19) United States
(12) Patent Application Publication
(10) Pub. No.: US 2024/0253323 A1
(43) Pub. Date: Aug. 1, 2024

(54) METHOD OF PRODUCING DISTINCT DIE-CUT PATTERNS IN DUNNAGE PRODUCT

(71) Applicant: Clayton Cooper, Clifton Park, NY (US)

(72) Inventor: Clayton Cooper, Clifton Park, NY (US)

(21) Appl. No.: 18/104,787

(22) Filed: Feb. 1, 2023

(51) Int. Cl. B31D 5/00

(52) U.S. Cl. CPC B31D 5/0039; B31D 2205/0047

(57) ABSTRACT

A method of producing distinct die-cut patterns in dunnage system, is disclosed. The method comprises the steps of: (a) feeding an uncut roll of base material into the dunnage system without cutting the distinct die-cut patterns from the uncut roll of base material, wherein the uncut roll of base material is then cut into sheets and sheet stacked to form sheets of base material, and the sheet is then re-wound on a roll to form a roll of base material, and (b) feeding the roll of base material from the roll through a die-cutting process configured to partially die-cut the roll of base material to form a partially die-cut base material.

### BACKGROUND OF THE INVENTION

### A. Technical Field

The present invention generally relates to the field of packaging systems and methods. More specifically, the present invention relates to a method and system for producing distinct patterns in dunnage products and converting them into a sheet stock or roll stock material to use as a protective packaging material.

### B. Description of Related Art

Shipping and packaging industries utilize a wide variety of protective packaging with fillers. Typical protective packaging or dunnage is produced by running a continuous strip of paper into a machine. The paper is crumpled to form a long strip of dunnage with many folds. These crumpled papers are filled inside the void spaces of a transportation container. It may effectively prevent damage to the product during transport and/or storage. However, it is not a permanent solution for transporting or shipping products over a long distance or the product is heavy.

Few existing patent references attempted to address problems cited in the background as prior art over the presently disclosed subject matter are explained as follows:

A prior art US 20200020253 A1 assigned to Kenneth Lin, entitled “PSA Label Rolls using Spent Release Liners and methods and apparatus for making them” discloses PSA Label Rolls using spent liners and a novel continuous process to convert a stack of face material into a roll of label stock by affixing adhesive coated face material onto a liner. Provides a process to recycle waste liner from conventional roll label stock application machines. Uses an ultra-high solids adhesive that needs no drying. Roll label stock made by such a process provides large cost savings and beneficial environmental impact. However, the above-mentioned method eliminates the production of new PSA labels using a new liner thus using a recycled liner. The method does not produce new PSA using a recycled liner.

Therefore, there is a need for an improved method for creating distinct die-cut patterns in materials used in the production of dunnage products. Also, there is a need for a method to cut a sheet or roll feed stock into sheets and stacked or rewound on a roll. Further, there is a need for a method to maximize the conversion of the flat sheets or roll stock into three-dimensional dunnage pieces.

### SUMMARY OF THE INVENTION

The present invention generally discloses a method for producing distinct patterns in materials used in the production of dunnage products without cutting the pattern from the sheet or roll fed stock of base material. Also, the present invention discloses a method for converting the die-cut base material into a sheet stock or roll stock material to use as a protective packaging material.

According to the present invention, the method utilizes the system configured to feed or load an uncut roll stock of base material, thereby creating distinct cut patterns without cutting the pattern from the roll stock of base material. In one embodiment, the dunnage materials product obtained from this method may be cut into sheets and sheet stacked or re-wound on a roll. In one embodiment, the method utilizes an uncut roll stock of base material configured to create distinct cut patterns without cutting the pattern from the base material. The base material may be in sheet or roll fed stock. In one embodiment, the method is configured to create a partially die-cut material when the dunnage production system does not have a die-cutting section in it. Further, the partially die-cut sheets or roll stock may be fed into the system configured to convert them into the finished pieces.

In one embodiment, the method comprises the following steps. At one step, an uncut roll stock of base material is fed into the system. In one embodiment, the uncut roll stock of base material is fed into the system without cutting the pattern from a sheet or roll fed stock. At another step, the uncut roll stock from a roll is fed via an unwind section for a die-cutting process configured to partially die-cut the undie-cut roll stock of base material. In one embodiment, the tension on the unwound roll of the base material is reduced to near zero to eliminate the separation of the die-cut material. In one embodiment, an undie-cut base material is utilized to perform the die-cutting process. The tension control section is configured to feed the roll stock of base material from a roll through the die-cutting process.

The roll stock from a roll is fed through the die-cutting process that will die-cut the base material on a single layer basis. Once the die-cut is done, the tensile strength of the roll stock is no longer in the roll stock web in total. The tensile strength of the roll stock or web is limited to the multiple points that are not cut through during the die-cutting process. In one embodiment, the multiple points provide multiple connections that allow the roll stock to be fed as partially die-cut roll stock. The partially die-cut roll stock of base material is then rewound back to a roll form of partially die-cut paper, etc. so that it could then be placed into the dunnage production system that does not have a die-cut section incorporated into it. If the system has a die-cutting section in it then the feed into the system will be uncut rolls of paper whether it will be recycled or virgin or plastic, etc.

In one embodiment, the roll includes predetermined shape in a continuous and uncut format. In one embodiment, the sheets are fed one sheet at a time for die cutting the plurality of die-cut openings and a plurality of uncut tabs so that the die-cut sheet could be restacked as a partially die-cut sheet.

In one embodiment, the roll stock base material comprises a plurality of die-cut openings configured to positively drive the sheet stock material. In one embodiment, the method further receives measurement information and controls the functions of the system to utilize a unique and specific die-cut pattern to maximize the conversion of the flat fed sheets or roll stock into dunnage pieces. In one embodiment, the unique folded and formed shape is utilized to maximize the conversion from flat stock material to a three-dimensional form creating a high-volume dunnage product. In one embodiment, the method further controls the fed rate of the sheet stock or roll stock material throughout the system.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a method of producing distinct die-cut patterns in materials used in a production of dunnage product in an embodiment of the present invention.

FIG. 2 shows a typical die-cut pattern of a material feed through the dunnage production system to produce a dunnage lose fill product in one embodiment of the present invention.

FIG. 3 shows the typical die-cut material with close tabs in one embodiment of the present invention.

FIG. 4 shows a tab sheet of die-cut material in one embodiment of the present invention.

FIG. 5 shows a top view of roll stock of the die-cut material in one embodiment of the present invention.

FIG. 6 shows a side view of the roll stock of the die-cut material in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

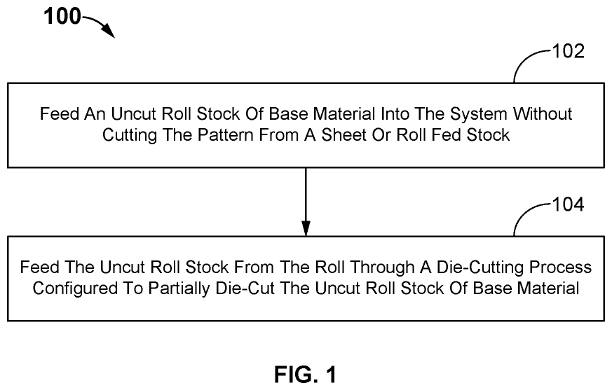

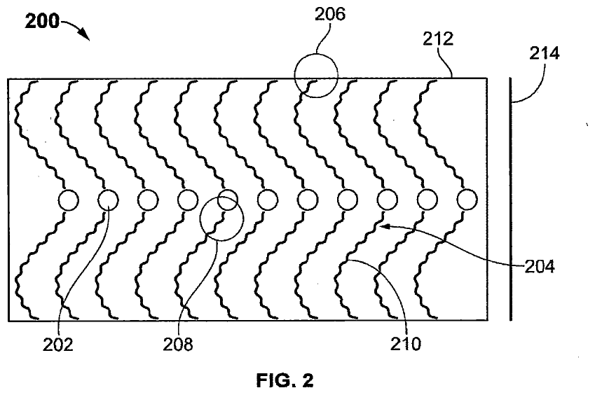

Referring to FIG. 1, a method 100 of producing distinct patterns in dunnage materials or base material 200 (as shown in FIG. 2) using a system or conversion machine, according to an embodiment of the present invention. The method 100 is an innovative and intelligent dunnage material manufacturing process to produce a dunnage base material product from a sheet stock or roll stock of base material 200 for use in a dunnage production system. The method 100 is an improved solution that utilizes the conversion machine to convert the base material 200 into die-cut roll stock or sheet stock material that are used to produce the dunnage product or loose fill packing material. The base material 200 may be a recycled paper, virgin paper, or other suitable plastic material. In one embodiment, the method 100 utilizes the recycled and/or virgin paper configured to create a distinct cut pattern without cutting the pattern from the sheet or roll fed stock.

In one embodiment, the method 100 utilizes an uncut roll stock of base material 200 configured to create various distinct cut patterns without cutting the pattern from the sheet or roll fed stock. The base material 200 may be in a form of sheet stock or roll fed stock. In one embodiment, the method 100 is configured to create a partially die-cut material when the dunnage production system does not have a die-cutting section in it. In one embodiment, the partially die-cut material obtained from this method 100 may be cut into sheets and sheet stacked or re-wound on a roll. Further, the partially die-cut sheets or roll stock may be fed into the dunnage production system configured to convert them into the finished pieces.

In one embodiment, the method 100 comprises the following steps. At step 102, an uncut roll stock of base material is fed into the system. In one embodiment, the uncut roll stock of base material is fed into the system without cutting the pattern from a sheet or roll fed stock. At step 104, the uncut roll stock from a roll is fed for a die-cutting process configured to partially die-cut the undie-cut roll stock of base material. In one embodiment, the tension on the unwound roll of the base material is reduced to near zero to eliminate the separation of the die-cut material. In one embodiment, an undie-cut base material is utilized to perform the die-cutting process.

The roll stock from a roll is fed through the die-cutting process that will die-cut the base material 200 on a single layer basis. Once the die-cut is done, the tensile strength of the roll stock is no longer in the roll stock web in total. The tensile strength of the roll stock or web is limited to the multiple points that are not cut through during the die-cutting process. In one embodiment, the multiple points provides multiple connections that allow the roll stock to be fed as partially die-cut roll stock. In one embodiment, the partially die-cut roll stock of base material is then rewound back to a roll form of partially die-cut paper, etc. so that it could then be placed into the dunnage production system that does not have a die-cut section incorporated into it. If the system has a die-cutting section in it then the feed into the system will be uncut rolls of paper whether it will be recycled or virgin or plastic, etc.

In one embodiment, the roll includes predetermined shape in a continuous and uncut format. In one embodiment, the sheets are fed one sheet at a time for die cutting the plurality of die-cut openings and a plurality of uncut tabs so that the die-cut sheet could be restacked as a partially die-cut sheet.

In one embodiment, the roll stock base material comprises a plurality of die-cut openings configured to positively drive the sheet stock material. In one embodiment, the method 100 further receives measurement information and controls the functions of the system to utilize a unique and specific die-cut pattern to maximize the conversion of the flat fed sheets or roll stock into dunnage pieces. In one embodiment, the unique folded and formed shape is utilized to maximize the conversion from flat stock material to a three-dimensional form creating a high-volume dunnage product. In one embodiment, the method 100 further controls the fed rate of the sheet stock or roll stock material throughout the system.

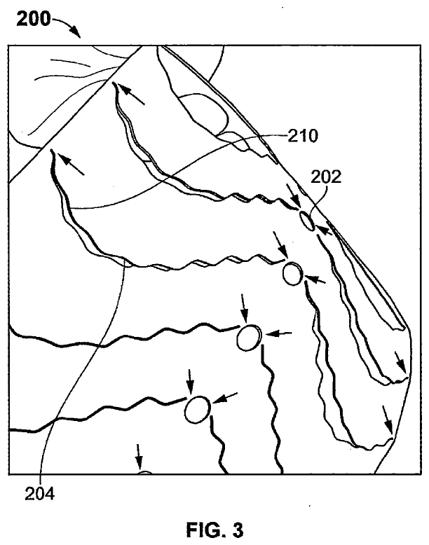

Referring to FIGS. 2-6, a typical die-cut pattern of the base material 200 resulting in a dunnage lose fill product when fed through the dunnage production system using distinct die-cut materials created using method 100, according to one embodiment of the present invention. The base material 200 has a plurality of die-cut openings 202 and a plurality of tabs 204 with die-cut patterns 210 along its length. Each die-cut opening 202 is provided at a certain distance from each other. Each tab 204 extends between the die-cut opening 202 and the sides of the base material 200. In one embodiment, the base material 200 has a pre-defined length 212 and width 214. In one embodiment, an uncut roll of base material 200 has a dimension of about 6 to 12 inches in width versus a large roll of base material that comes off a paper production line. In one embodiment, the large rolls of base material 200 may have the dimension of about 48 inches in width. The base material 200 has been previously die-cut in a manner as to allow the dunnage to remain in a partially connected manner since the die-cut pattern 210 is not fully cut through the base material 200 in multiple locations (206 and 208).

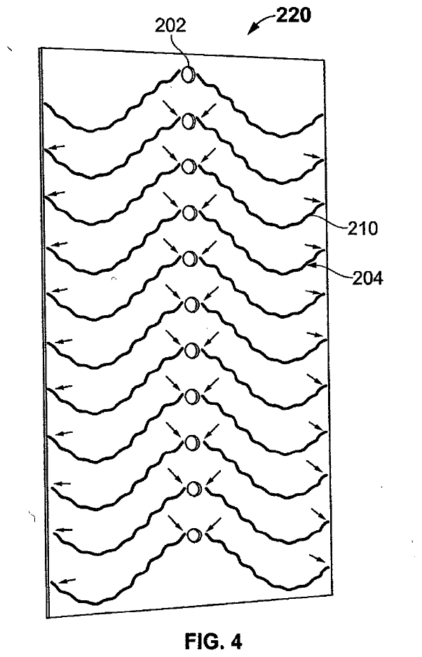

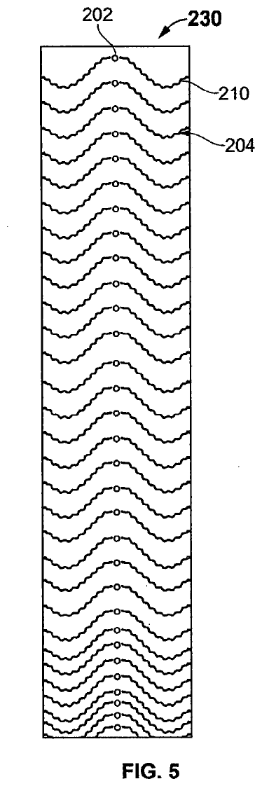

In one embodiment, the die-cut pattern 210 is created without cutting the pattern from the sheet stock 220 (as shown in FIG. 4) or roll fed stock 230 (as shown in FIG. 5) into a single piece. In one embodiment, the base material 200 in a sheet form may receive the sheet stock in flat form, the material has previously been die-cut in a manner as to allow the dunnage base material to remain in a partially connected manner since the die-cut pattern was not fully cut through the material in multiple locations (206 and 208).

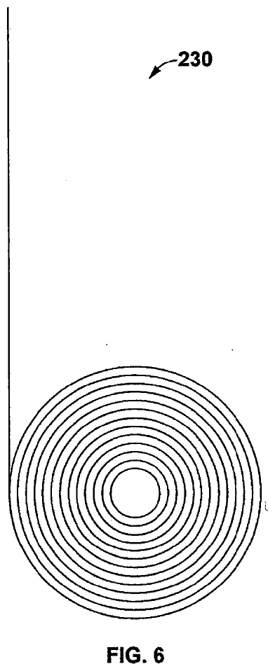

FIGS. 4-6 exemplarily illustrate a typical die-cut pattern 210 of the base material 200 in different forms, according to one embodiment of the present invention. In one embodiment, the base material 200 may be in a sheet format or sheet stock 220 (as shown in FIG. 4). In one embodiment, the base material 200 may be in a roll fed stock format or roll stock 230 (as shown in FIG. 5 and FIG. 6). In one embodiment, the die-cutting process for sheet stock 220 is the same except that the sheets are fed one sheet at a time then die-cut leaving points or retaining tabs not cut through so that the die-cut sheet is restacked as a partially die-cut sheet. If the sheet stock 220 is die-cut without retaining tabs 204 then the die-cut sheet would result in multiple die-cut pieces and not connected in any way. The uncut tabs 204 allow the sheet stocks 220 to be restacked and then the stacks of partially cut sheet stocks 220 are placed into a sheet feeder of the dunnage production system instead of the roll stock feed system. Similarly, the restacked partially cut base material 200 is placed into a roll stock feeder of the system to produce roll stock 230.

Advantageously, the method of the present invention produces distinct die-cut patterns in dunnage base materials that will be used to produce a protective packaging material. The method creates distinct die-cut patterns without cutting the pattern from the roll stock or sheet stock of base material.

Further, the method of the present invention is designed to be effective in the application. The effective method for preparing loose fill packing material in formed dunnage particles from a sheet stock or roll stock material provides good marketability for the manufacturer. The user benefits from the improved method, which may provide considerable market interest to the product.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1. A method of producing die-cut patterns in a base material, the method comprising:
feeding an uncut base material to a die-cutting process;
in the die-cutting process, partially die-cutting the uncut base material to produce a partially die-cut base material having a plurality of die-cut openings;
positively driving the partially die-cut base material by means of the plurality of die-cut openings; and
cutting the partially die-cut base material into sheets or winding the partially die-cut base material into a roll.

2. The method of claim 1, wherein the uncut base material comprises a flat form.

3. (canceled)

4. The method of claim 1, further comprising controlling a feed rate of the uncut base material.

5. (canceled)

6. The method of claim 1, wherein the partially die-cutting the uncut base material to produce the partially die-cut base material is practiced on a single layer basis.

7. The method of claim 1, wherein the partially die-cut base material comprises multiple points that are not cut through during the die-cutting process.

8. The method of claim 7, wherein the multiple points that are not cut through comprise multiple connections that allow the partially die-cut base material to be fed and cut into the sheets or wound on the roll.

9. The method of claim 1, wherein the uncut base material comprises a predetermined shape in a continuous and uncut format.

10. (canceled)

11. (canceled)

12. (canceled)

13. (canceled)

14. The method of claim 1, wherein the method further comprises minimizing tension in the partially die-cut base material to avoid separation of the partially die-cut base material.

15. The method of claim 14, wherein the minimizing tension in the partially die-cut base material to avoid separation is practiced in a tension control section.

16. The method of claim 1, wherein partially die-cutting the uncut base material comprises die-cutting the uncut base material wherein multiple points of the partially die-cut base material are not cut through.

17. The method of claim 16, wherein the multiple points of the partially die-cut base material that are not cut through comprise multiple connections that allow the partially die-cut base material to be fed.

18. The method of claim 16, wherein the multiple points of the partially die-cut base material that are not cut through comprise uncut tabs.

19. (canceled)

20. The method of claim 1, wherein the method further comprises processing the partially die-cut base material into dunnage.

21. The method of claim 1, wherein the uncut base material comprises a paper-based material.

22. A method of producing die-cut patterns in a base material for use as dunnage, the method comprising:
providing the base material having a longitudinal direction, a transverse direction, and opposing longitudinal edges;
introducing a plurality of longitudinally-spaced, transversely-extending perforations and a plurality of openings to the base material to produce a perforated base material having uncut portions between the longitudinally-spaced, transversely-extending perforations and the opposing longitudinal edges;
positively driving the perforated base material by means of the plurality of openings; and
producing dunnage from the perforated base material.

23. The method of claim 22, wherein the perforated base material further comprises uncut portions between the plurality of openings and the longitudinally-spaced, transversely-extending perforations.

24. A dunnage base material comprising:
a partially die-cut sheet comprising:
a longitudinal direction, a transverse direction, and opposing longitudinal edges;
a plurality of longitudinally-spaced, transversely-extending perforations;
uncut portions between the longitudinally-spaced, transversely-extending perforations and the opposing longitudinal edges; and
a plurality of longitudinally-spaced hollow openings.

25. (canceled)

26. The dunnage base material of claim 24, wherein the plurality of longitudinally-spaced hollow openings comprises a plurality of circular hollow openings.

27. The dunnage base material of claim 24, wherein each of the plurality of longitudinally-spaced hollow openings is sized and positioned to be engaged to drive the dunnage base material.

28. The dunnage base material of claim 24, wherein the plurality of longitudinally-spaced hollow openings is centrally positioned along the partially die-cut sheet.
